(19) United States
(12) Patent Application Publication
(10) Pub. No.: US 2022/0401205 A1
(43) Pub. Date: Dec. 22, 2022

(54) APPARATUS, SYSTEM AND METHOD FOR MONITORING A CONDITION

(71) Applicant: Edward PENTY, Aldborough (GB)

(72) Inventor: Edward PENTY, Aldborough (GB)

(21) Appl. No.: 17/638,457

(22) PCT Filed: Aug. 28, 2020
(86) PCT No.: PCT/GB2020/052062

§ 371 Date: Feb. 25, 2022

(30) Foreign Application Priority Data
Aug. 29, 2019 (GB) 1912384.3

(51) Int. Cl. A61D 17/00

(52) U.S. Cl. CPC A61D 17/002; A61D 17/008; A61D 17/006

(57) ABSTRACT

A monitoring apparatus (1) for monitoring of a condition state in a quadruped mammal is described, including at least a housing portion (3) comprising a plurality of motion sensors (11) disposed to sense movement in at least two degrees of freedom, a data capture module to capture movement data generated by the motion sensors, wireless transmitter module (17) to transmit captured data to a remotely located hub (21), and a power source (19) to provide electrical power; and an attachment portion (5) to engage the housing in a fixed orientation onto a surface of the body of an animal to be monitored, for example on the torso or neck. A mounting system including such an apparatus and a method of monitoring of a plurality of quadruped mammals to draw inferences in relation to a condition state using such an apparatus are also described.

The invention relates to an apparatus, a system and a method for monitoring of certain condition states in quadruped mammals, and in particular agricultural livestock such as bovine livestock. More particularly, the invention relates to an apparatus, method and system for monitoring of a condition state in relation to one or both of state of estrus and progress towards and through parturition.

### INTRODUCTION

In the field of animal husbandry there are various scenarios where it is likely to be highly desirable to have a clear indication of a condition state of an animal in order to take appropriate action and/or have appropriate personnel in position to be in attendance.

More specifically in the business of breeding livestock, there are various stages of the breeding process where such monitoring of a condition state in the intended mother is desirable and of commercial value. Two such stages have particular significance. The first of these is at or about the point of estrus (which term when used herein will be understood to include variant spellings including oestrus, estrous and oestrous) and the second is at or about the point of parturition.

This may be true in relation to any quadruped mammal, and in particular a quadruped mammal where there is a particular commercial value to having mating and birthing optimized. Possible animals include without limitation cattle, sheep, goats, camels, llama, horses, racing bloodstock, etc. By way of example much discussion herein focuses on bovine livestock, and particularly on the dairy industry, but it will be understood that this is by way of example and that the advantages of the invention are not limited to these examples.

It may be desirable for various reasons for appropriate personnel to be in attendance immediately prior to, at or immediately following parturition of certain animals to assist in the birth procedure, to provide medical attention or assistance to the mother and/or her offspring, or otherwise to take various desirable actions in relation to the husbandry of the mother and/or her offspring immediately prior to, at or immediately following the birth of the offspring.

It is accordingly known to be desirable for apparatus to be provided which can detect the onset of delivery and automatically alert a remotely located attendant.

Known apparatus to effect this may take a variety of forms, and comprise several basic types. For example, devices may be provided which are intended to be inserted into the birth canal of a pregnant animal and which give a response signal when actuated by expulsion or imminent expulsion at parturition. Other devices may be located externally of the animal and seek to detect specific electrical impulses associated with the process of parturition. Yet further devices may seek to obtain information from certain animal behaviour which is seen as characteristic of the onset of the birth process. For example, in relation to cows, sustained tail raising is commonly observed and devices have been proposed which are worn on the tail of the expectant mother, and which make an assessment of the readiness for birth based on sustained tail raising position.

Similarly, the accurate monitoring of the estrus cycle can be of significant commercial value in ensuring that any artificial insemination or mating process is performed in a timely and accurate manner. This is known to be particularly true in relation to bovine livestock, and dairy cattle in particular. The cows' estrus duration time is known to be associated with particularly characteristic behaviour.

During a preliminary phase, the cow may be pursued by other cows which attempt to mount her, but she does not accept the other cows' mount. During the next phase, generally known as the standing heat phase, the cow shows a willingness to accept the mount, and stands to do so. Standing heat is strongly indicative of imminent ovulation, and represents the beginning of the countdown in terms of hours to the most appropriate time for mating or artificial insemination if it is desired to obtain the highest possible conception rate.

The ideal mating or artificial insemination time following such indication varies according to beef versus dairy cows and also according to breed. Ovulation, which is the breaking of the egg out of the corpus luteum, is a critical moment. Until this happens the egg cannot be fertilized. From the moment a cow receives semen, semen starts to die, so the nearer the time is that the semen reaches the egg (having spent time travelling from the cervix up the uterine horn), the higher the chances of fertilisation. Ovulation typically happens 16-18 hours from the onset of standing heat. This can be earlier or later. When super ovulating cows, some cows will have larger (older) embryos at flushing at 7 days post insemination and some will have smaller embryos which means they have ovulated later. Thus, accurate timing of the onset of the standing heat phase can improve prediction of the optimum timing for introduction of semen and consequently improve conception rate.

Traditional methods of watching for standing heat based on direct observation are time consuming and labour intensive. Accordingly, various devices to permit for some element of remote monitoring have been proposed. In cattle these include the following.
1. A leg bracelet called a pedometer which counts the number of steps a cow takes in a day (the more activity, the more likely she is on heat).
2. Neck collars which monitor a cow's neck movements (the more there are the more likely she is to be on heat).
3. Patches worn by the cow on her back which give an indication of the number of standing heat mounts. At their simplest, adhesive patches which progressively wear away with successive mounts might be used. Periodic observation of the state of wear of such a patch gives an indication of the number of mounts and therefore of the progress towards or into standing heat.

There is a significant commercial driver to develop improved ways of determining the likelihood of certain states in quadruped livestock, and in particular in cattle, for example including at least one or both of the current state of estrus and the current state of progress of parturition.

The foregoing methods and devices are generally relatively crude, may well still require significant attendant intervention, and may not always produce accurate reproducible results representative of the desired animal state.

There is a general desire to develop an apparatus, a system and a method for monitoring of quadruped livestock, and in particular bovine livestock, to determine a condition state, in particular in relation to estrus and/or in relation to the progress of parturition, which mitigates some or all of the above disadvantages.

There is a particular desire to provide a system which can monitor such states remotely, and for example which can provide for an alert to an attendant at the appropriate time, thus reducing unnecessary attendance and maximising attendance resources.

### SUMMARY OF THE INVENTION

In accordance with the invention in a first aspect, a monitoring apparatus for monitoring of certain condition states in a quadruped mammal is provided, the monitoring apparatus comprising:
a housing portion comprising:
   a plurality of motion sensors disposed to sense movement in at least two degrees of freedom;
   a data capture module to capture movement data generated by the motion sensors;
   a wireless transmitter module to transmit captured data to a remotely located hub;
   a power source to provide electrical power;
an attachment portion to engage the housing in a fixed orientation onto a surface of the body of an animal to be monitored, for example on the back, and for example such as to locate the housing in the pelvic region.

In use with the apparatus attached to a test animal, data relating to movement of the animal in the at least two degrees of freedom are collected by the data capture module and transmitted to a remotely located hub for eventual data processing against established reference movement behaviour data and using algorithms based on established reference movement behaviour to enable inferences to be drawn about certain condition states, in particular in relation to estrus and/or parturition, in the test animal. The invention encompasses carrying out this data processing at the hub and/or at a further data processing station remote from the hub, and also encompasses some optional data processing at the monitoring apparatus.

A key to the invention in all its aspects is that movement data are captured that are representative of behaviour characteristic of certain condition states, in particular in relation to estrus and/or parturition, in the test animal. In some instances for example it may be particularly desirable to capture movement data from the region of dorsal articulation between the pelvic girdle and the spine. Movement from this region has been found to be particularly effectively characteristic of certain condition states in some quadruped mammals such as bovines, and in particular has been found to be particularly effectively indicative of a state of progress to and through estrus and/or of a state of progress to and through parturition.

This is discussed below in particular as an effective target location in bovines. However, this is by way of example only. The appropriate target movement region may differ with the species and the condition to be monitored. For example, for pigs a region on the loin closer to but rearwards of the shoulder has been found to be effective.

The precise location of the housing (and hence the sensors) on the body of an animal may be optimised for the species and the condition to be monitored. Moreover, the precise location of the housing (and hence the sensors) need not be at the target region, but merely needs to be suitable to collect characteristic data from the target region. Suitable locations may include locations on the torso or neck and the attachment portion is configured to engage the housing in a fixed orientation onto a surface of the torso or neck of an animal to be monitored, for example on the back of the torso or neck.

By way of example, to monitor the pelvic region for example, a convenient location may be at or behind the vicinity of the point of dorsal articulation between the pelvic girdle and the spine and the attachment portion may be adapted to engage the housing in a fixed orientation onto a surface of the back of an animal to be monitored such as to locate the housing at or behind the vicinity of the point of dorsal articulation between the pelvic girdle and the spine. For example for the collection of data relevant to the monitoring of parturition an optimum position may be at the point of dorsal articulation between the pelvic girdle and the spine. For example to detect onset of standing heat an optimum position may be further back, behind the point of dorsal articulation between the pelvic girdle and the spine. These positions may be particularly optimized for bovines. Other positions may be optimized for other species. For example as noted, for pigs a region on the loin closer to but rearwards of the shoulder has been found to be effective.

To facilitate movement capture, the attachment portion is adapted to engage the housing in a fixed orientation onto a surface location on the torso or neck of an animal to be monitored that is suitable to capture data related to movement in the target region. In the example case where the target region is the region of dorsal articulation between the pelvic girdle and the spine the surface location may for example in this case be on the back in the vicinity of the pelvic region.

The surface location may for example be a location on a dorsal midline. However, other locations off the midline of the back or neck may be suitable to capture movement from the target region, for example locations on the surface of the torso about the rib cage, about the pelvic girdle etc.

As used herein, reference to the sensing of movement in a degree of freedom is reference to the standard model of motion of a rigid body in three dimensions whereby a body is free to change position by translation along three perpendicular axes in combination changes in orientation by rotation about the same three perpendicular axes.

In accordance with such a standard model of motion with reference to an actual or notional horizontal level such as the ground defining three orthogonal axes in longitudinal, transverse and vertical directions, a body is free to translate forward or backward on a longitudinal axis (sometimes referred to as surge), to translate left or right on a transverse axis (sometimes referred to as sway), to translate up or down on a vertical axis (sometimes referred to as heave); and to tilt side to side about the longitudinal axis (sometimes referred to as roll), tilt forward or backward about the transverse axis (sometimes referred to as pitch), and to tilt left or right about the vertical axis (sometimes referred to as yaw).

The housing portion has a plurality of motion sensors disposed therein in predetermined orientation with reference to a notional set of orthogonal axes x, y, z. The attachment portion acts in use to engage the housing in a fixed orientation onto a surface of the back of an animal such that the x axis is oriented along the back of the animal in an anterior-posterior direction parallel to its spine, the y axis is oriented along the back of the animal in a direction transverse to the spine, and the z axis is oriented through the body of the animal in a generally dorsal-ventral direction orthogonal to the other two.

Preferably, the motion sensors comprise at least one motion sensor positioned to sense translational movement forward and backward along an x-axis of the housing and at least one motion sensor positioned to sense rotational movement side to side about an x-axis of the housing.

Thus, the said at least two degrees of freedom comprise at least translational movement along the x-axis of the housing and rotational movement about the x-axis of the housing.

Thus, with the monitoring apparatus attached to a test animal in use and with the animal in a typical standing position, the motion sensors comprise at least one motion sensor positioned generally to sense to and fro surge movement of the animal in an anterior-posterior direction generally parallel to its spine and at least one motion sensor positioned generally to sense side to side roll movement of the animal about an anterior-posterior axis generally parallel to its spine.

The key to the invention in all its aspects is that movement data generated by the motion sensors capture movement from the pelvic region and for example the region of dorsal articulation between the pelvic girdle and the spine.

To that end the attachment portion is provided suitably adapted to engage the housing in a fixed orientation onto a surface of the back of an animal to be monitored such as to locate the housing in the pelvic region and for example the vicinity of the point of dorsal articulation between the pelvic girdle and the spine and the method of the invention comprises collecting movement from the pelvic region and for example the vicinity of the dorsal articulation between the pelvic girdle and the spine.

In this sense, the requirement to be in the vicinity of the point of dorsal articulation between the pelvic girdle and the spine will be understood to be a requirement to be sufficiently close that the movement captured by the motion sensors includes at least a substantial element attributable to movement of the animal body at or in the vicinity of the region of dorsal articulation between the pelvic girdle and the spine, that motion including but not limited to that attributable to the articulation of the sacroiliac joint. For example, the attachment portion of the monitoring apparatus is configured to engage the housing portion of the monitoring apparatus on the dorsal surface of the animal closely adjacent the sacroiliac joint and the method comprises collecting data from the dorsal surface of the animal closely adjacent the sacroiliac joint for example by attachment of such a monitoring apparatus.

In particular, in the preferred case, the motion sensors capture movement from the region of dorsal articulation between the pelvic girdle and the spine at least comprising to and fro thrust generally along the elongate direction of the spine and roll about the spine.

Although useful data can be drawn from all motion of the animal in all degrees of freedom, these two aspects of motion in respect of these two degrees of freedom are found to be particularly useful, especially in relation to each of the two condition states discussed above of particular commercial significance in animal husbandry, estrus and parturition.

In relation to state of estrus, the measurement and collection of data in respect of these at least two degrees of freedom of movement may allow inferences to be drawn in relation to standing heat. Notably, the movement response in respect of these at least two characteristic degrees of freedom is likely to be different during the preliminary phase of estrus, when the cow is pursued by other animals and subject to attempted mount but does not stand to accept them, and the standing heat phase of estrus, when she is prepared to stand to accept mounts. Accordingly, appropriate processing of data against reference data for behaviour at these two stages of estrus, even from just these two types of movement, can allow surprisingly accurate inferences to be drawn about the time of onset of standing heat, and thus provide significant commercial advantages in relation to effective timing of conception, and of optimum timing of artificial insemination in particular.

In particular, sensors which collect even merely these two types of data may allow inferences to be drawn about the duration of a given mount. It is not only frequency but duration of mount and response of the subject animal that is characteristic of standing heat. Enhanced accuracy of prediction of estrus can be achieved by processing data in an attempt to obtain information concerning both frequency and duration of mount, and response of the subject animal, and the apparatus of the invention is uniquely suited to collecting raw data to effect this.

This can be contrasted with prior art products aimed at estrus detection, and which typically log only number and frequency of mounts. By contrast the invention enables data to be collected that may enable a determination of time and duration of a mount, whether a mount exceeds a given time, total cumulative time of mounts exceeding a given time, response of the subject animal etc, and more successfully detect standing heat in consequence.

In a further refinement with this use in mind, the housing portion may additionally comprise a sensor specifically adapted to detect the duration of an external contact or proximity, such as may be directly indicative of a mount of a test animal by another animal, for example in the form of a contact sensor or proximity sensor. A simple pressure switch may be used to detect pressure from above the apparatus. More preferably a sensor that responds to the proximity of an external biological presence above the apparatus, for example via capacitive coupling, may give better results. Such a refinement further improves the ability of the monitoring apparatus of the invention to provide data for processing suitable for the more accurate prediction of standing heat.

In relation to preparedness and progress of parturition, the measurement and collection of data in respect of these at least two degrees of freedom of movement is again particularly advantageous. First, many target mammals are known to exhibit certain characteristic behaviour in preparing for parturition and the birth of offspring which might broadly be called nesting behaviour, and which involves certain characteristic body movements. Data collected even for these at least two degrees of freedom only can be processed against reference data for such characteristic behaviour to allow inferences to be drawn about the time of onset of or progress of parturition. However, the collection of data from the vicinity of the point of dorsal articulation between the pelvic girdle and the spine offers the potential additionally to collect data which may be characteristic of uterine contractions as such, and may enable direct inferences to be drawn about the onset of or progress of or occurrence of uterine contractions. Such data may be far more characteristic of the progress of the parturition than, for example, motion data collected in relation to tail raising alone or even more general movement alone.

Of course, it will be understood that for these and other condition states to be monitored, further data collected from further degrees of freedom of movement may enhance the utility of the date and accuracy of inferences drawn about the occurrence of a particular condition state.

Further sensors may be provided to sense movement in further degrees of freedom comprising up to six degrees of freedom selected from: translational movement along an x-axis of the housing portion, translational movement along a y-axis of the housing portion, translational movement along a z-axis of the housing portion, rotational movement about an x-axis of the housing portion, rotational movement about a y-axis of the housing portion, rotational movement about a z-axis of the housing portion.

Except where express qualification or context clearly demands otherwise, references to x, y and z axes herein shall be understood to be references to orthogonal axes of the housing portion of the monitoring apparatus. References to horizontal or vertical spatial direction will be understood to be made with reference to a notional ground surface in use. References to a longitudinal direction will be understood to be references to a horizontal direction generally following the elongate direction of an animal to be monitored, and references to a transverse direction to be references to a horizontal direction generally transverse to the elongate direction of the animal to be monitored.

With the monitoring apparatus attached to a quadruped test animal there will be a general correspondence between the x, y and z axes and the respective anterior/posterior, lateral, and dorsal/ventral directions in the animal, and with the animal in a normal standing position a further general correspondence between these and the respective longitudinal, transverse and vertical spatial directions, but it will be understood as inherent in the invention that these relative positions change as the animal moves. Thus, where any of the above terms are used herein as exemplification of a particular in-use orientation it will be understood that this is by way of illustration and no limitation of the invention to a particular in-use orientation is implied.

The housing portion defines the respective x, y and z axes and provides a fixed mounting for at least the plurality of motion sensors to hold the same in a fixed orientation relative to the housing portion.

The housing portion conveniently comprises a housing enclosure containing any or all of:
a plurality of motion sensors disposed to sense movement in at least two degrees of freedom;
a data capture module to capture movement data generated by the motion sensors;
a wireless transmitter module to transmit captured data to a remotely located hub;
a power source to provide electrical power;
other optional components or modules of the housing portion referred to herein.

The housing enclosure conveniently comprises a fixed mounting for any or all of the components of the apparatus contained therein. In particular, the housing enclosure conveniently comprises a fixed mounting for at least the plurality of motion sensors to hold the same in a fixed orientation relative to the housing enclosure and hence relative to as notional x, y and z axis of the housing portion.

The housing enclosure conveniently comprises a protective casing enclosing the components therein. The housing enclosure conveniently comprises a mechanically protective casing and is for example rigid. The housing enclosure conveniently comprises an environmentally protective casing and is for example waterproof.

The attachment portion is in fixed mechanical relationship with the housing portion such that in use attached to a subject animal it is adapted to engage the housing portion in the desired position and orientation on the animal.

The attachment portion form example comprises a flexible material having a surface adapted to fix upon and for example bond with the hair on the dorsal surface of the animal and for example an adhesive surface. In a convenient arrangement, the attachment portion comprise paired wings of flexible material extending either side of the housing portion and with a lower surface adapted to fix upon and for example bond in face to face contact with the hair on the dorsal surface of the animal and thus locate the monitoring apparatus in position.

The invention requires a plurality of motion sensors disposed to sense movement in at least two degrees of freedom, with the apparatus arranged such that in use these two degrees of freedom most preferably correspond generally to forwards and backwards motion or surge, and side to side roll movement, of the test animal with the apparatus fixed on its back. It is a requirement of the invention that suitable sensors are provided to detect motion in at least two degrees of freedom, and optionally up to all six degrees of freedom, relating to motion commonly referred to as surge, sway, heave, roll, pitch and yaw.

It is desirable that the sensors are adapted to be located within a housing container in compact and close association, and are amenable to be addressed by the data capture module to allow the capture of movement data generated by the motion sensors and facilitate its onward transmission for processing.

The precise configuration and conformance of the sensors is not specifically limiting to the invention and various suitable sensors which are inherently capable of detecting such forms of motion are known. In a possible embodiment, at least some of the motion sensors comprise accelerometers. Individual motion sensors may be single-axis or multi-axis access accelerometers.

Suitable compact accelerometers include piezoelectric, piezoresistive, capacitive, gyroscopic and micro-electromechanical accelerometers.

The housing portion includes, in addition to the motion sensors, a data capture module to capture movement data generated by the motion sensors, a wireless transmitter module to transmit captured data to a remotely located hub, a power source to provide electrical power.

The invention encompasses additional monitors, being located within the housing portion or provided for use elsewhere, for example to monitor an animal condition.

For example in a possible embodiment the monitoring apparatus as above described is provided in combination with one or more supplementary condition monitoring modules, adapted to be located elsewhere in association with the animal, and comprising at least one condition sensor to sense an animal condition, a condition data capture module to capture data generated by the condition sensor(s); and a wireless transmitter module to transmit captured data to a remotely located hub.

The hub is in use the same hub that receives data from the wireless transmitter module in the housing, allowing such data to be co-processed as desired.

Preferably, the condition sensor(s), condition data capture module and wireless transmitter module are compactly associated together in a common enclosure.

A particularly useful supplementary condition monitoring module might be adapted to measure an internal condition, for example including temperature and/or internal pH, and for example stomach pH. In a suitable such case the supplementary condition monitoring module comprises an enclosure containing one or both of a temperature and/or internal pH sensor; a data capture module to capture data generated by the sensor(s); and a wireless transmitter module to transmit captured data to a remotely located hub. The enclosure is adapted to cause the supplementary condition monitoring module to be retained within the body of a test animal, for example in a stomach of a test animal, and in the case of a ruminant for example in the reticulum. The enclosure is for example weighted for this purpose.

In a likely preferred mode of use, plural monitoring apparatus supplied to a corresponding plurality of animals will connect to a single hub to allow for herd monitoring. Conveniently additionally therefore the housing portion includes an identification module giving a unique identifier to a monitoring apparatus which can be read by the data capture module and associated with the data transmitted to the hub.

This allows for the identification of individual devices in a preferred envisaged use of multiple devices in accordance with the first aspect of the invention respectively attached to and monitoring multiple animals, for example collected at a single location such as a barn, with a common hub.

Thus, in a more complete second aspect of the invention, a monitoring system comprises:
a plurality of monitoring apparatus in accordance with the first aspect of the invention;
a hub apparatus comprising a wireless receiver module to receive captured movement data and preferably associated identification data transmitted in use from the wireless transmitter modules of each of the said monitoring apparatus, and a data transmission module comprising a data communication link to communicate the received data to a central processing system for processing against established reference movement behaviour data and/or algorithms based on established reference movement behaviour data to enable inferences to be drawn about certain condition states.

A suitable central processing system is adapted to process the movement data against established reference movement behaviour data and/or algorithms based on established reference movement behaviour data and output inferences about certain condition states. A more complete system of the second aspect of the invention accordingly includes such a central processing system in data communication with the hub via the data communication link. The hub may include the central processing system and/or may be adapted via its data communication link to communicate the received data to a remotely located central processing system.

In a third aspect of the invention, a method is provided of monitoring of a plurality of quadruped mammals to draw inferences in relation to a condition state of any or each of the said mammals, in particular in relation to one or both of state of estrus and progress towards and through parturition, based on the foregoing principles.

Specifically, in a third aspect of the invention, a method of monitoring of a plurality of quadruped mammals to draw inferences in relation to a condition state comprises:
providing a plurality of monitoring apparatus comprising:
   a housing portion comprising a plurality of motion sensors disposed to sense movement in at least two degrees of freedom; a data capture module to capture movement data generated by the motion sensors;
   a wireless transmitter module to transmit captured data to a remotely located hub; a power source to provide electrical power;
   an attachment portion to engage the housing in a fixed orientation onto a surface of the back of an animal to be monitored;
attaching each of the said apparatus in a fixed orientation on to a surface of the back of a respective animal to be monitored, preferably such as to locate the housing in the pelvic region, and for example at or behind the vicinity of the point of dorsal articulation between the pelvic girdle and the spine of the animal;
and in respect of each such animal, preferably dynamically in real time;
capturing movement data generated by the motion sensors;
transmitting captured data to a remotely located hub;
collecting data at the remotely located hub;
processing the data against established reference movement behaviour data and/or using algorithms based on established movement behaviour;
drawing inferences therefrom about a condition state of the animal, for example including inferences in relation to estrus and/or parturition.

The method may thus comprise for example a method of collecting data using a system of the second aspect of the invention, and discussion below of operation protocols will be understood to apply to both the method and the system. Each monitoring apparatus is for example a monitoring apparatus of the first aspect of the invention and preferred features of the apparatus will be understood by analogy.

The central processing system for example includes a central processor module adapted to process the movement data against established reference movement behaviour data and/or algorithms based on established reference movement behaviour data and output inferences about certain condition states. The central processing system for example includes a library module comprising library data of reference movement behaviour data and/or a further storage module storing addressable movement data processing algorithms based on established movement behaviour. The method comprises for example comparing movement data against library data of reference movement behaviour data and/or applying a processing algorithm based on established movement behaviour to draw inferences about a condition state.

In a preferred mode of operation, the system of the second aspect of the invention and the method of the third aspect of the invention provides what is necessary for the remote monitoring of a group of animals that are preferably in a relatively undispersed location, such is likely for a group of animals being monitored for example in advance of mating, or in advance of imminent birth. A monitoring apparatus is attached to each animal, and collects movement data which is transmitted wirelessly via a suitable short range wireless protocol to a common hub equipped with a compatible wireless receiver.

Ultimately, the collected data for each of the plurality of animals in the group is processed in a suitable central processor against a library of established reference movement behaviour data for the animal under test and/using algorithms based on established movement behaviour for the animal under test, thereby to enable inferences to be drawn about certain condition states.

A particular advantageous flexibility of the invention is that the system and method at their most general confer particular flexibility with regard to the protocol by means of which the above analysis and alert is effected.

For example, in one possible protocol, the hub is configured for data collection purposes only, and the data transmission module is adapted for onward transmission of the data to a remote central processing system, for example via a wired data link such as an Ethernet link or a longer range wireless data link such as a cellular telephone link. The method comprises transmitting data from the hub to a remote central processing system for processing.

The remote central processing system includes a central processor module adapted to perform the necessary data processing against reference data, and to draw the appropriate inferences regarding a condition of the animal.

Such a remote central processing system may for example be in data communication with multiple hubs being operated by multiple users. The system may comprise a plurality of hubs each in data communication with a common central processing system and the method may employ a plurality of hubs communicating data to a common central processing system.

Advantageously, this not only simplifies the hubs but also allows for common storage and updating of information and data processing techniques.

Additionally or alternatively, a central processor may be provided within the hub to perform at least some data processing steps. The invention also admits the provision of a data processing capability within each apparatus to perform some data processing steps.

The purpose of the invention is to enable data indicative of those inferences to be transmitted on to a user of the system, in order to alert a user of the system of the occurrence of or status of an animal in relation to a particular condition state, and for example to indicate that attendance to a particular animal is appropriate, that a particular animal is ready to give birth, that a particular animal is ready for insemination etc.

Accordingly, regardless of the data collection and processing protocol, the central processing system preferably further includes a condition state determination module, and for example an alert state determination module, to determine a particular condition state in relation to a monitored condition from the inferences drawn from the movement data analysis, and preferably additionally a transmission module transmit that determined condition state in a manner receivable by a user of the system, for example as an alert. The method by analogy comprises determining a condition state, and for example an alert state, from the inferences drawn from the movement data analysis, and transmitting the same in a manner receivable by a user of the system, for example as an alert.

Again, advantageously, the system and method of the invention lend themselves to a number of communication protocols to effect this. Most usefully however, a condition state signal such as an alert signal should be generated by and transmitted from the central processing system to a user module carried by a remote user of the system and adapted to receive such a signal and display the determined condition state for example as an alert. In this way, a user of the system who is remotely located from the animals and the hub is able to receive a condition state notification.

A user module may be a bespoke user module provided as an optional part of the system. More usefully in many instances, a user module comprises a software application on a mobile device, such as a mobile cellular telecommunications device or short range wireless communication enabled device, and the condition state and for example alert signal is transmitted thereto over the cellular telephone network or web-based or other short range wireless enabled communication network.

Thus, in such a case the user module comprises a suitably programmed mobile cellular telecommunications device or short range wireless communication enabled device having a suitable display means to display the condition state and/or a suitable alarm means to generate an alert. Thus, in such a case the method comprises transmitting the determined condition state to a suitably programmed mobile cellular telecommunications device over a cellular telephone network or short range wireless communication enabled device over a web-based or other short range wireless enabled communication network and preferably additionally displaying the condition state on the mobile cellular telecommunications device or short range wireless communication enable device and/or generating an alert on the mobile cellular telecommunications device or short range wireless communication enabled device.

The invention in all its aspects applies generally to quadruped mammals. The invention in all its aspects applies in particular to quadruped mammals kept for domestic purposes such as agricultural or zoological purposes. The invention in all its aspects applies in particular to the field of breeding of offspring of quadruped mammals. The invention in all its aspects applies in particular to the monitoring of a condition state related to one or both of state of estrus and progress towards and through parturition. The invention in all its aspects applies in particular to the monitoring of a condition state related to one or both of standing heat and imminent/active onset of parturition.

The invention in all its aspects applies in particular to a quadruped mammal where there is a particular commercial value to having mating and parturition/birthing optimized. Possible example animals include without limitation cattle, pigs, sheep, goats, camels, llama, horses, racing bloodstock, etc.

The invention in all its aspects in particular applies advantageously to ungulate mammals.

The invention in particular applies advantageously to cattle, that is, to species in the subfamily Bovinae, and especially the genus Bos, and most particularly to the domesticated cow, Bos taurus. The invention in all its aspects is particularly advantageously applied in the field of dairy cattle husbandry. Examples are discussed herein in that context, but the skilled person will appreciate that it will be possible to apply the principles of the invention as appropriate to other animals such as those above listed.

The method of the third aspect of the invention may thus use a system of the second aspect of the invention based on plural apparatus of the first aspect of the invention and preferred features of one aspect will be understood to apply to other aspects where applicable by analogy.

### BRIEF DESCRIPTION OF DRAWINGS

The invention will now be described by way of example only with reference to FIGS. 1-4 of the accompanying drawings in which:

FIG. 1 illustrates an apparatus in accordance with the first aspect of the invention positioned for use in the pelvic region of a cow;

FIG. 2 shows the apparatus of FIG. 1 in isolation and with a housing container open to illustrate the contents of the housing portion of the apparatus;

FIG. 3 illustrates schematically a complete system employing plural apparatus such as those illustrated in FIGS. 1 and 2;

FIG. 4 illustrates an embodiment of a supplementary condition monitoring module suitable for use with the apparatus of FIG. 1 in the system of FIG. 3;

FIG. 5 shows the relationship between

### DETAILED DESCRIPTION

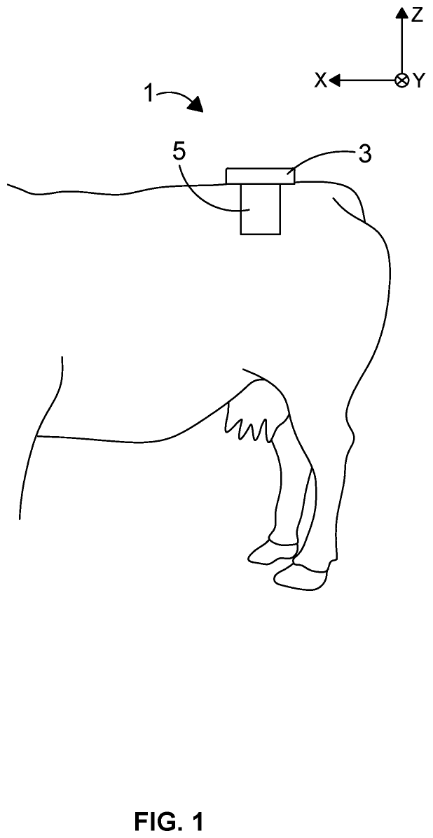

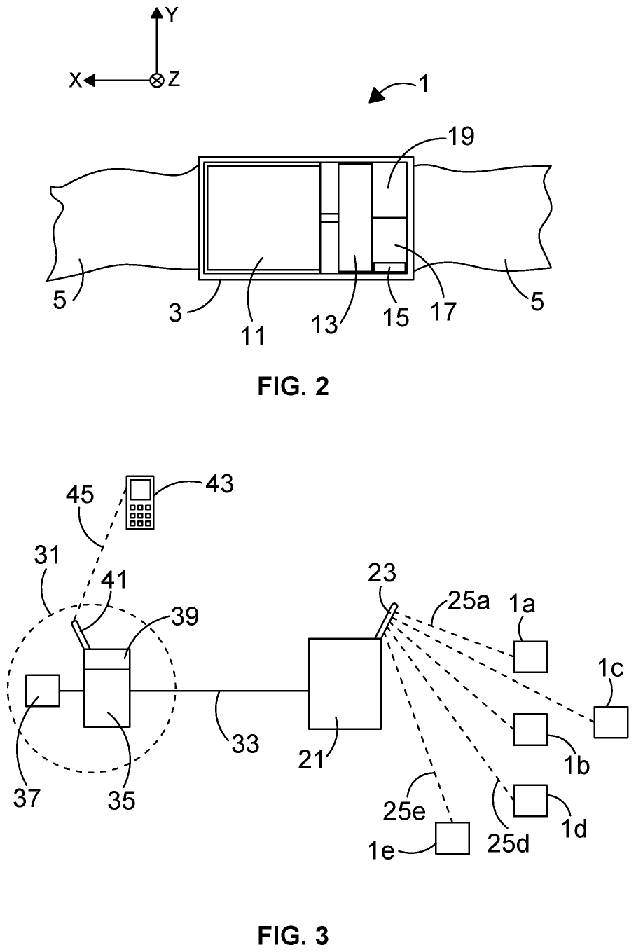

An embodiment of a monitoring apparatus operating to the principles of the invention is shown attached for use to a cow to be monitored in FIG. 1 and in more detail in partly-open plan view in FIG. 2.

The monitoring apparatus (1) generally comprises a housing enclosure (3) and a pair of attachment wings (5) which have lower surfaces suitable for attaching the apparatus to the back of the cow, as shown in FIG. 1, for example using a suitable applied adhesive. The apparatus is attached such that the housing (3), and more particularly the movement sensors located therein, are positioned in the pelvic region. To monitor progress of calving this will preferably be generally above the sacroiliac joint so as to monitor motion in that region, and in particular motion associated with dorsal articulation between the pelvic girdle and the spine. To monitor state of standing heat, a location situated further back on the cow's tail head may be preferred.

The housing defines nominal orientation axes x, y, z illustrated in FIGS. 1 and 2. In use when properly attached to the cow, and with the cow in a normal standing position, the x axis is generally horizontal and aligned with the dorsal-ventral direction of the cow along its spine, the y axis is a generally horizontal transverse direction, and the z axis is generally vertical. Of course it will be understood that as these axes are defined with reference to the housing of the apparatus, as the cow moves, then depending on the movement, the orientation of the axes relative to the ground and at least some parts of the cow may move accordingly.

The housing (3) comprises a rigid container which serves to contain the motion sensors and other instruments that make up the functioning components of the apparatus, to locate and orientate the motion sensors in particular, to protect the components environmentally, and to associate the components together operatively in a compact manner. The container is for example a rigid plastics casing.

The container is shown partly open in plan view and with its contents represented to some extent schematically in FIG. 2.

Those contents include a motion sensor module (11) comprising a plurality of motion sensors disposed to sense movement in at least two degrees of freedom, preferably including at least forward and backward motion along the x axis and roll about the x axis, and optionally including any or all of the six degrees of freedom corresponding to and fro motion on the x, y and z axes and rotation about the x, y and z axes of the housing.

Specific individual sensors are not shown, and their specific form is not necessarily pertinent to the invention, but in the illustrated embodiment the sensor module (11) is intended to comprise a plurality of suitably orientated accelerometers thus adapted to sense motion of the animal in various directions corresponding to the directional axis of the housing.

A data capture module (17) collects and captures the data from the various sensors, preferably dynamically in real time, and to this end may include, or the sensor module itself include, a suitable clock timer (not separately shown). The data capture module may additionally perform some initial data processing and to this end may include a suitable processor (not separately shown). The data capture module additionally associates the data with a unique apparatus identifier provided by the identification module (15) which might for example be a simple passive device.

The collected, identified and optionally initially partly processed data may then be transmitted, dynamically in real time or periodically as desired, via the data transmitter module (17). The data transmitter module (17), shown more completely in operation in FIG. 3, is designed in normal operation to communicate wirelessly with a local hub, and accordingly adapted to operate to a suitable short range wireless protocol. Optionally, it may additionally be adapted to receive signals back from the hub.

A battery pack (19) provides the source of electrical power.

An example of an operation of a system embodying a plurality of individual apparatus of the type described with reference to FIGS. 1 and 2 is shown in FIG. 3. Such a system might for example be employed in a barn or similar location to monitor a group of animals at a similar stage of a given process in the husbandry cycle, for example at similar stage of estrus, or similar stage of pregnancy.

Separately identifiable and interrogatable individual devices (1a-1e) are attached to respective animals in the manner illustrated in FIG. 1. Each device has a different identification module, by means of which data uniquely identifying the device, and consequently uniquely identifying the animal to which it is attached, can be transmitted to the hub. The identification module may also provide to be read locally, to allow identification of the animal in situ.

A hub (21) is provided which communicates locally with each of the monitoring devices (1a-1e) by establishing a wireless communication link (25a-25e) between a wireless receiver (23) on the hub and the transmitter modules on the respective apparatus.

The system admits to a number of operational communication protocols between the hub and the multiple monitoring devices as desired. For example, data transmission may be on a continuous or batch basis, and may be initiated periodically by the individual monitoring devices or under interrogation by the hub.

The hub is in data communication with a central processor which performs primary data processing of the collected movement data from the various apparatus and consequently the various animals being monitored and processes the same against reference data standards and algorithms to determine a condition state.

Although the invention admits to the possibility of at least some of this processing being performed at the hub, in the illustrated embodiment, a remote central processing system (31) at a remote central processing site is employed. Advantageously, this might allow for multiple hubs to communicate raw or relatively minimally processed data to a single central point, which single central point performs the primary assessment and status determination, with the advantages of potential for intelligent learning and potential for immediate update and improvement that go with such central and distributed system.

Each hub in the system is in data communication with the central processing system (31) via a data link (33). In an envisaged mode of operation this is a longer distance data link than that between a set of monitoring devices and their hub, which may be wired, and for example effect connection via a wired telecommunications network and for example via an Ethernet protocol, or wireless, and for example effect connection via the cellular telephone network or a satellite communication protocol.

In the illustrated example the central processing system (31) includes a central processor (35) that receives and processes the movement data from the various apparatus, which central processor is in data communication with a data library (37) which carries characteristic movement data patterns associated with particular condition states, and optionally additionally stores standard addressable movement data processing algorithms based on established movement behaviour associated with particular condition states. The processor is configured to compare movement data against the library data and/to apply a processing algorithm to the movement data based on established movement behaviour to draw inferences about a condition state of the animal from the movement data.

The central processing system further includes a state identification and alert module (39) which is adapted to be triggered when a state or condition has been determined to within a predetermined level of certainty, based on the collected movement data comparison with the library data and/or applied to a suitable algorithm, that a particular condition is likely to exist, and further to issue an alert in respect of that condition.

The central processing system is preferably adapted to transmit this condition state for example as an alert to a user of the system. It is of course possible to transmit this alert directly back along the original data communication path and to the individual monitoring devices. However, advantageously the system of the invention provides for remote monitoring by a user, so that a user does not need to be in attendance at the location where the animals are kept until and unless a condition state signal or alert signal indicating that attendance may be necessary is received.

Accordingly, a condition state signal or alert signal is preferably transmitted to a remove receiver module held by the user. Most simply, as in the illustrated embodiment, the receiver module is a cellular communication device such a cellular telephone, tablet or the like programmed with suitable software to receive and display the condition state signal or alert signal to a user, which is in data communication with a transmitter (41) at the central site via the cellular telephone network via cellular telephone network link (45). Alternatively, bespoke receivers and condition state signal or alert signal devices may be used.

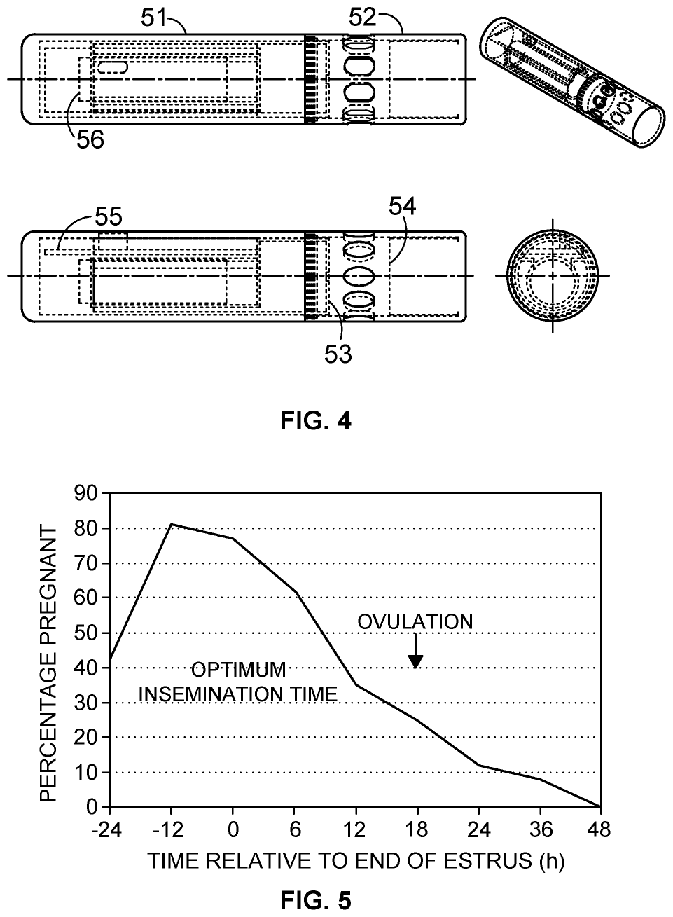

FIG. 4 illustrates an embodiment of a supplementary condition monitoring module suitable for use with the apparatus of FIG. 1 in the system of FIG. 3. A bolus is shown comprising an enclosure that comprises male (51) and female (52) screwed sections which are screwed together to contain a temperature and an electrolyte sac (53) to comprise a pH sensor. The bolus is designed in use to be retained in and measure the temperature and pH within the reticulum. The bolus is swallowed, but is optionally weighted with a makeweight (54) at one end and shaped such that it will not pass beyond the reticulum. This provides an admirably non-invasive means of monitoring both internal temperature of the cow and the pH conditions within the reticulum.

The enclosure may additionally contain a data capture and transmitter module which is designed in normal operation to communicate wirelessly with the local hub. allowing temperature and pH data from the animal to be transmitted for co-processing into the same system as the data from the apparatus of FIG. 1, for example advantageously to provide further information to inform a condition assessment. In the example an integral PCB (55) is included in the enclosure. A battery power source (56) is also provided.

Preferably, the apparatus and system described herein is adapted to monitor a condition state in relation to one or both of the state of estrus of the cow and the progress towards and through parturition of the cow.

In the former case, the criticality of timing of insemination relative to ovulation to maximize conception rates is known, as shown for example in FIG. 5. Providing a more accurate determination of standing heat, which is known to relate to ovulation, can improve prediction of the optimum timing for introduction of semen and consequently improve conception rate. In the latter case, attendance of appropriate personnel able to take timely steps to deal with issues associated with parturition is beneficial to the success of the birthing process and to the progress of both mother and offspring. In both of these cases, the invention provides an admirably effective system for monitoring in real time the state of the cow, and offers an enhanced accuracy of determination of the state, ensuring that appropriate personnel may be in attendance at an appropriate time and/or that appropriate intervention steps are taken at an appropriate time to maximise efficiency of the conception and/or parturition/birth processes.

1. A monitoring apparatus for monitoring of a condition state in a quadruped mammal comprising:
a housing portion comprising:
a plurality of motion sensors disposed to sense movement in at least two degrees of freedom;
a data capture module to capture movement data generated by the motion sensors;
a wireless transmitter module to transmit captured data to a remotely located hub;
a power source to provide electrical power;
an attachment portion to engage the housing in a fixed orientation onto a surface of the body of an animal to be monitored.

2. A monitoring apparatus in accordance with claim 1 wherein the attachment portion is configured to engage the housing in a fixed orientation onto a surface of the back of an animal to be monitored such as to locate the housing in the pelvic region.

3. A monitoring apparatus in accordance with claim 2 wherein the attachment portion is configured to engage the housing in a fixed orientation onto a surface of the back of an animal to be monitored such as to locate the housing in the vicinity of or behind the point of dorsal articulation between the pelvic girdle and the spine.

4. A monitoring apparatus in accordance with claim 1 wherein the motion sensors are disposed in the housing portion in predetermined orientation with reference to a notional set of orthogonal axes x, y, z, and the motion sensors comprise at least one motion sensor positioned to sense translational movement along the x-axis of the housing and at least one motion sensor positioned to sense rotational movement about the x-axis of the housing.

5. A monitoring apparatus in accordance with claim 4 wherein the attachment portion is configured to engage the housing in a fixed orientation onto a surface of the back of an animal such that the x axis is oriented along the back of the animal in a direction parallel to its spine, the y axis is oriented along the back of the animal in a direction transverse to the spine, and the z axis is oriented through the body of the animal in a direction orthogonal to the other two.

6. A monitoring apparatus in accordance with claim 1 wherein the motion sensors are disposed in the housing portion in predetermined orientation with reference to the housing portion such that with the housing portion attached to a test animal in use with the animal in a typical standing position, the motion sensors comprise at least one motion sensor positioned generally to sense to and fro surge movement of the animal in an anterior-posterior direction generally parallel to its spine and at least one motion sensor positioned generally to sense side to side roll movement of the animal about an anterior-posterior axis generally parallel to its spine.

7. A monitoring apparatus in accordance with claim 1 wherein the attachment portion is adapted to engage the housing in a fixed orientation onto a surface of the back of an animal to be monitored to locate the housing such that the movement captured by the motion sensors in use includes at least a substantial element attributable to movement of the animal body at or in the vicinity of the region of dorsal articulation between the pelvic girdle and the spine, optionally at least comprising to and fro thrust generally along the direction of the spine and roll about the spine.

8. A monitoring apparatus in accordance with claim 1 wherein the housing portion further comprises a contact sensor adapted to detect the presence and duration of an external contact or proximity.

9. A monitoring apparatus in accordance with claim 1 comprising motion sensors disposed to sense movement in up to six degrees of freedom selected from: translational movement along an x-axis of the housing portion, translational movement along a y-axis of the housing portion, translational movement along a z-axis of the housing portion, rotational movement about an x-axis of the housing portion, rotational movement about a y-axis of the housing portion, rotational movement about a z-axis of the housing portion.

10. A monitoring apparatus in accordance with claim 1 wherein the housing portion comprises a housing enclosure containing any or all of:
the plurality of motion sensors disposed to sense movement in at least two degrees of freedom;
the data capture module to capture movement data generated by the motion sensors;
the wireless transmitter module to transmit captured data to a remotely located hub;
the power source to provide electrical power;
additional components or modules.

11. A monitoring apparatus in accordance with claim 1 wherein the attachment portion comprise paired wings of flexible material extending either side of the housing portion in fixed mechanical relationship with the housing portion each having a surface adapted to be fixed upon an animal.

12. A monitoring apparatus in accordance with claim 1 wherein at least some of the motion sensors are selected from: piezoelectric accelerometers, piezoresistive accelerometers, capacitive accelerometers, micro-electromechanical accelerometers and gyroscopic sensors.

13. A monitoring apparatus in accordance with claim 1 wherein the housing portion includes an identification module giving a unique identifier to a monitoring apparatus.

14. A monitoring apparatus in accordance with claim 1 provided in combination with a supplementary condition monitoring module comprising an enclosure containing one or both of a temperature and/or internal pH sensor; a data capture module to capture data generated by the sensor(s); and a wireless transmitter module to transmit captured data to a remotely located hub, wherein the enclosure is adapted to cause the supplementary condition monitoring module to be retained within the body of a test animal.

15. A monitoring system comprising:
a plurality of monitoring apparatus in accordance with any preceding claim;
at least one hub apparatus comprising a wireless receiver module to receive captured movement data from the wireless transmitter modules of each of the said monitoring apparatus, and a data transmission module comprising a data communication link to communicate the received data to a central processing system.

16. A monitoring system in accordance with claim 15 further comprising a central processing system adapted to process the movement data against established reference movement behaviour data and/or algorithms based on established reference movement behaviour data and to output inferences about one or more condition states, the central processor module being in data communication with the hub via the data communication link; wherein the central processing system optionally includes a library module comprising library data of reference movement behaviour data and/or a further storage module storing addressable movement data processing algorithms based on established movement behaviour; and optionally further wherein the central processing system further includes a condition state determination module, to determine a particular condition state, and a transmission module to transmit that determined condition state in a manner receivable by a user of the system.

17. A monitoring system in accordance with claim 15 comprising a plurality of hubs each in data communication with a common remotely located central processing system.

18. A monitoring system in accordance with claim 15 further comprising at least one user module adapted to receive the determined condition state and display the same, wherein the user module comprises a suitably programmed mobile cellular telecommunications device or short range wireless communication enabled device.

19. A method of monitoring of a plurality of quadruped mammals to draw inferences in relation to a condition state comprising:
providing a plurality of monitoring apparatus comprising:
a housing portion comprising a plurality of motion sensors disposed to sense movement in at least two degrees of freedom; a data capture module to capture movement data generated by the motion sensors; a wireless transmitter module to transmit captured data to a remotely located hub; a power source to provide electrical power;
an attachment portion to engage the housing onto a surface of the back of an animal to be monitored;
attaching each of the said apparatus in a fixed orientation on to a surface of the back of a respective animal to be;
and in respect of each such animal;
capturing movement data generated by the motion sensors;
transmitting captured data to a remotely located hub;
collecting data at a remotely located hub;
processing the data against established reference movement behaviour data and/or using algorithms based on established movement behaviour;
drawing inferences therefrom about a condition state of the animal.

20. A method in accordance with claim 19 wherein the attaching of each of the said apparatus in a fixed orientation on to a surface of the back of a respective animal to be monitored comprises attaching such as to locate the housing in the pelvic region.

21. A method in accordance with claim 20 wherein the attaching of each of the said apparatus in a fixed orientation on to a surface of the back of a respective animal to be monitored comprises attaching monitored such as to locate the housing in the vicinity of or behind the point of dorsal articulation between the pelvic girdle and the spine of the animal.

22. A method in accordance with claim 19 wherein the method comprises comparing movement data against library data of reference movement behaviour data and/or applying a processing algorithm based on established movement behaviour to draw inferences about a condition state.

23. A method in accordance with claim 19 wherein a central processing system is provided remotely located from and in data communication with one or more hubs, and the method comprises transmitting the collected data from the hub to the central processing system, and processing the data at the central processing system against established reference movement behaviour data and/or using algorithms based on established movement behaviour and drawing inferences therefrom about a condition state of the animal.

24. A method in accordance with claim 19 comprising determining a condition state; transmitting the determined condition state to a suitably programmed mobile cellular telecommunications device over a cellular telephone network or short range wireless communication enabled device over a web-based or other short range wireless enabled communication network; and displaying the condition state and/or generating an alert on the mobile cellular telecommunications device or short range wireless communication enabled device.

25. A method according to claim 19 wherein the condition state is related to one or both of state of estrus and progress towards and through parturition.
